(19) United States
(12) Patent Application Publication
(10) Pub. No.: US 2020/0398223 A1
(43) Pub. Date: Dec. 24, 2020

(54) Remineralization System and Method

(71) Applicant: Saline Water Conversion Corporation, Al-Jubail (SA)

(72) Inventors: Ahmed Saleh Mohammed Alamoudi, Al-Jubail (SA); Nikolay Voutchkov, Winter Springs, FL (US); Seungwon Ihm, Al-Khobar (SA)

(21) Appl. No.: 16/448,792

(22) Filed: Jun. 21, 2019

(51) Int. Cl. B01D 61/08; B01D 61/02; B01D 61/58; C02F 1/44

(52) U.S. Cl. CPC B01D 61/08; B01D 61/027; B01D 61/022; B01D 61/58; C02F 2103/08; B01D 2311/08; B01D 2311/06; B01D 2313/28; B01D 2317/025; C02F 1/442

(57) ABSTRACT

A system and method for producing high quality potable water by re-mineralization of desalinated water is provided. The retentate rejected from a nanofiltration unit becomes a source of mineral-rich divalent ions for mixing with the desalinated water being produced by a desalination unit, thereby reducing or eliminating the need for separate supply from outside sources of chemicals needed to obtain potable water that meets various drinking water standards. The nanofiltration unit may be located in a desalination upstream and/or downstream of the desalination unit, and the amount of flow of the nanofiltration retentate supplied to the re-mineralization unit relative to the amount of desalinated water flow may be adjusted to achieve the desired potable water quality.

The present invention relates to design and operation of facilities associated with generation of potable water, and in particular to a system and method for efficient and economical recovery of minerals and re-mineralization of water using minerals generated as a byproduct of operation of a divalent ion-selective filtration process.

### BACKGROUND OF THE INVENTION

Distillate water produced by a desalination process (i.e., desalinated water) is known to typically be slightly acidic, typically in the range of 6.0-6.5 pH in the case of distillate from a thermal evaporator process. This is also the case for permeate (desalinated water) produced using a reverse osmosis (RO) membrane, because bicarbonate ions (HCO₃⁻) are largely rejected at the RO membrane and discharged in concentrated form in the reverse osmosis retentate outlet stream, while most of the CO₂ in the feed water passes through the RO membrane in the permeate outlet stream.

Due to the slight acidity of the desalinated water from such processes, the water needs to be treated to raise its pH in order to protect the downstream water transportation and distribution system from corrosion, as well as to meet drinking water guidelines. In the prior art, this has been accomplished in thermal and membrane desalination plants with post-treatment re-mineralization (also referred to as potabilization or re-carbonation) in a system that treats the desalinated water to produce potable water for civil consumption. A typical re-mineralization treatment includes increasing the concentrations of calcium ions (Ca⁺⁺) and bicarbonate ions (HCO₃⁻). Usually total dissolved solids (TDS) and pH are increased through the re-mineralization, resulting in the final potable water having a better taste and a slightly positive saturation index.

An example design guide for potable water quality to be considered in designing the re-mineralization system of a desalination plant is summarized in Table 1.

TABLE 1

| | | |
|---|---|---|
| Parameter | Minimum | Maximum |

| | | | | |
|---|---|---|---|---|
| Temperature | 20° | C. | 45° | C. |

| | | |
|---|---|---|
| pH | 8.3 | 8.6 |

| | | | | |
|---|---|---|---|---|
| Ca | 16 | mg/L | 24 | mg/L |

| | | |
|---|---|---|
| HCO₃ | 40 mg/L as CaCO₃ | 60 mg/L as CaCO₃ |

| | | | | |
|---|---|---|---|---|
| Turbidity | 0 | NTU | 2 | NTU |

| | | | |
|---|---|---|---|
| TDS | — | 110 | mg/L |

| | | |
|---|---|---|
| LSI | +0.1 | +0.3 |

An example of a common re-mineralization process in the desalination industry is schematically illustrated in FIG. 1, with parameters at various locations in the process shown in Table 2, below.

In this system an inlet flow of desalinated water 1 enters the re-mineralization system, whereupon approximately 20-50% of the desalinated water is diverted via branch 2 to a re-mineralization process train. The first step of the re-mineralization process is to inject CO₂ gas 3 into a portion of the diverted desalinated water in a CO₂ absorber 4. The CO₂ gas may be supplied, for example, in the form of released CO₂ gas generated in an upstream thermal evaporator, CO₂ received from a CO₂ generation plant, or from some other source. The chemical reaction in the CO₂ absorption process is CO₂+H₂O→H₂CO₃.

Following the water acidifying process, a re-carbonation process is performed in a limestone filter 5, where the portion of the diverted desalinated water that passes through the CO₂ absorber 4 rejoins the remainder of the diverted desalinated water. In this re-carbonization step the acidified water reacts with limestone (CaCO₃), according to the relationship H₂CO₃+CaCO₃→Ca(HCO₃)₂. The stoichiometry of the reactions provides for a mole of calcium bicarbonate (Ca(HCO₃)₂) to be produced for each mole of carbon dioxide (CO₂) that reacts.

Following re-carbonization, the output from the limestone filter 5 passes to a degassifier 6 which removes remaining free CO₂, in preparation for the final stages of the re-mineralization process.

After degasification the diverted portion of the desalinated water is rejoined with the portion that bypasses the re-mineralization process train. The entire volume of water may then be further treated by injection of chemicals that complete preparation of the desalinated water for potable use, such as injection of chlorine gas 7 for disinfection purposes and injection of sodium hydroxide (NaOH) to meet pH and LSI parameter objectives (the absorbed CO₂ reacts with the NaOH according to the relationship NaOH+CO₂→Na⁺+HCO₃⁻). The previous removal of free CO₂ in the degasification process minimizes the amount of NaOH that would otherwise be depleted by the excess CO₂, thus minimizing the amount of NaOH that must be supplied to the remineralization process. The resulting potable water 9 is then ready for downstream transport and consumption.

Example parameters at different locations along the FIG. 1 re-mineralization process are shown in Table 2:

| | Desalinated | Post- | CO2 | | | |
|---|---|---|---|---|---|---|
| | Water | treatment | Absorber | Limestone | | Potable |
| Location | Inlet 1 | Inlet 2 | Outlet 4 | Filter 5 | Degasifier 6 | Water 9 |
| Flow (%) | 100 | 25 | 5 | 25 | 25 | 100 |
| TDS (ppm) | 13 | 13 | — | 287 | 287 | 84 |
| pH | 6.0 | 6.0 | 4.1 | 7.1 | 7.2 | 8.6 |
| LSI | −7.1 | −7.1 | — | −0.2 | −0.1 | 0.2 |

Another common re-mineralization practice in the desalination industry is to use lime milk (Ca(OH)₂). In this process, the acidified diverted portion of the desalinated water from the CO₂ absorber reacts with lime in the re-carbonization step to reach a CaCO₃ saturation point according to the relationships of 2CO₂+Ca(OH)₂→2Ca⁺+2HCO₃⁻, and Ca(HCO₃)₂+Ca(OH)₂→2CaCO₃+2H₂O.

Other re-mineralization processes are also known, although they usually are less economic than the above examples. These processes include use of hydrated lime+sodium carbonate (Ca(OH)₂+Na₂CO₃→CaCO₃+2NaOH), sodium bicarbonate (CaSO₄+2NaHCO₃→Ca(HCO₃)₂+Na₂SO₄), and calcium chloride (CaCl₂+2NaHCO₃→Ca(HCO₃)₂+2NaCl).

In a re-mineralization process, the higher the desalinated water's saturation index and pH, the easier the desalinated water is to treat, which saves operational and capital costs.

### SUMMARY OF THE INVENTION

An object of the present invention is to reduce or eliminate the need for procuring and using external chemicals (i.e., chemical supplies that must be brought in from outside sources) for re-mineralization of desalinated water. This and other objectives are achieved in association with operation of a desalination facility using nanofiltration (NF) technology, such as the system described in U.S. patent application Ser. No. 16/371,816, the disclosure of which is incorporated herein by reference.

The output from nanofiltration of a saline source water is a concentrated brine (i.e., retentate) that is rich in concentrated divalent ions, i.e., a concentration several times higher than naturally occurring in source saline water (e.g., seawater). A portion of the NF retentate output stream is used as a source of minerals for re-mineralization, thereby reducing or eliminating the need to use commercial re-mineralization chemicals such as lime or limestone, and providing the opportunity for beneficial reuse of a portion of the brine generated by the desalination plant. Both of these advantages can lead to substantial reductions in the overall cost of operating a desalination plant.

In an example embodiment of the invention, a nanofiltration system is located upstream of a main desalination process (for example, a thermal or membrane desalination process). The NF system may treat all or a portion of the source saline water that is supplied to a main desalination process. Because of the pore size of NF, NF membranes are ion-selective, with higher rejection of divalent ions (including minerals such as calcium) and lower rejection of monovalent ions (such as sodium and chloride). The nanofiltration system therefore removes ions associated with undesired mineral deposits and scaling in downstream desalinators, while generating a reject (retentate) stream that is rich in divalent ions such as calcium and magnesium and low in monovalent ions. The lower-concentration NF permeate stream also benefits the desalination system by permitting lower boiling point elevation loss in thermal desalination processes and lower feed pressure requirements in membrane desalination processes.

The NF permeate stream is supplied to a downstream desalination system, while the NF retentate stream is discharged from the NF system. A portion of the NF retentate stream may be branched off to be fed into a re-mineralization system, where it is mixed with the desalinated water produced by the desalination system to re-mineralize the desalinated water and produce potable water. The ratio of NF retentate mixed with the desalinated water may be adjusted to obtain a desired potable water quality. NF retentate input to the re-mineralization system at a rate on the order of 1% of the flow of the desalinated water stream may be sufficient to treat the desalinated water.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic illustration of a re-mineralization process.

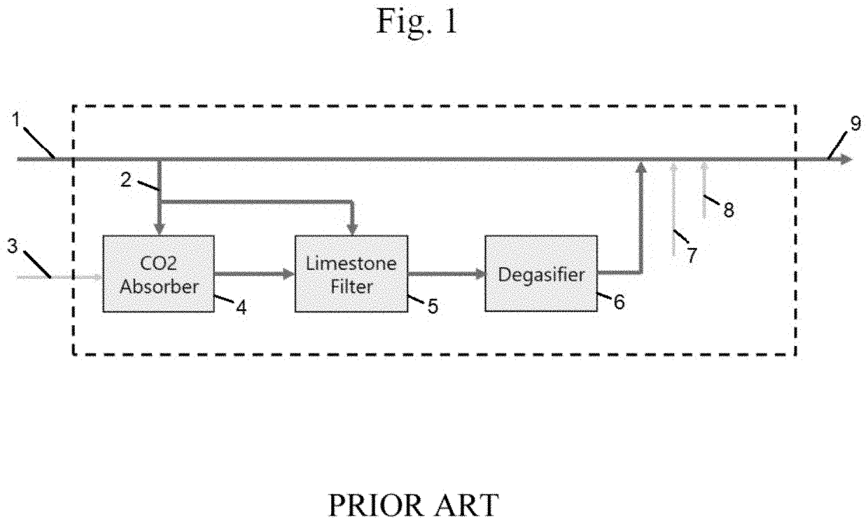

FIG. 2 is a schematic illustration of an embodiment of a desalination and re-mineralization system in accordance with the present invention.

FIG. 3 is a schematic illustration of another embodiment of a desalination and re-mineralization system in accordance with the present invention.

FIG. 4 is a schematic illustration of a further embodiment of a desalination and re-mineralization system in accordance with the present invention.

### DETAILED DESCRIPTION

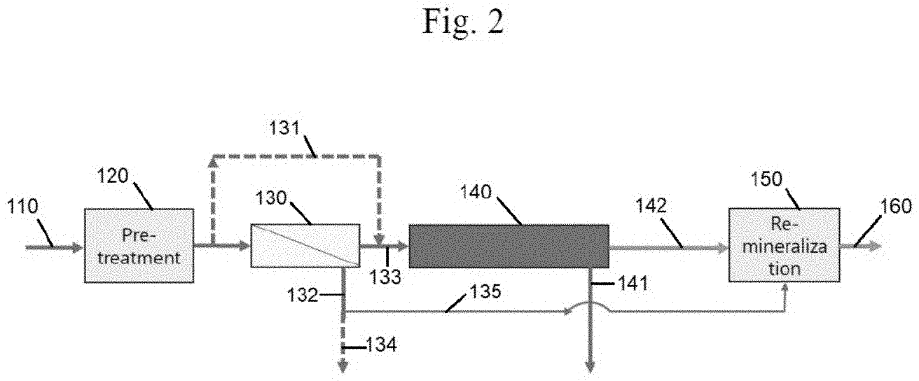

FIG. 2 schematically shows an example embodiment of a desalination facility arrangement in which an NF system is a part of the pretreatment of the source saline water, and is also a source of mineral ions for use in post-treatment of desalinated water into potable water meeting drinking water guidelines.

In this example, saline source water 110 passes through an initial pre-treatment process 120, such as debris removal, prior to some or all of the source water being input into the NF unit 130. If only a portion of the source water is to be treated by the NF unit 130, the remainder may bypass the NF unit via line 131 to be supplied to the downstream desalination unit 140. The desalination unit 140 further separates the saline water it receives into a desalination retentate stream 141 and a desalination permeate (desalinated water) stream 142.

In the NF unit 130, the source water is separated by membrane into a high divalent ion-concentration retentate stream that is rejected from the unit via discharge line 132, and into a low divalent ion-concentration permeate stream 133 that is input to the desalination unit 140, along with any bypass source water flow through line 131. A portion of the NF retentate stream 134 that is discharged via line 132 may be diverted via line 135 for use in the post-treatment re-mineralization unit 150.

At the re-mineralization unit 150 the desalination unit permeate stream 142 is mixed with the portion of the NF retentate discharge stream diverted via line 135 to treat the desalinated water to generate the output potable water stream 160.

The fluid flows and energy consumed in this desalination process should be balanced as necessary to maximize potable water production at the lowest operating cost. In one embodiment of the present invention, the desalinated water stream from the desalination unit 140 has a system TDS of 50 ppm and a pH of 5.2, with an estimated LSI value of −6.7. The NF retentate stream 132 has a TDS of 47,895 ppm (the dissolved solids being very rich in divalent ions useful in re-mineralizing desalinated water, either in the same desalination plant or a different desalination or in another water reclamation/wastewater treatment facility). In this example, a typical 1.1% volume mix of NF retentate 132 to the desalinated water 142 results in the mixed desalinated water and NF retentate having at least: (i) a better LSI value to protect receiving water piping against corrosion; (ii) elevated mineral content adequate to meet the drinking water quality requirements of the World Health Organization, US EPA drinking water regulations, and European Union drinking water standards; and (iii) an increase of the total amount of water produced by the desalination facility.

Example operating parameters in this embodiment are shown in Table 3, below. Note that the pH and LSI of the re-mineralized water in Table 3 could be further adjusted by adding CO₂ (from thermal desalination evaporator or other source), or other known methods, to reach the pH range of 6.5 to 9.0, and an LSI value close to neutral or a bit positive (e.g., +0.1-+0.3).

TABLE 3

| | | | | Re-mineralized Water | |
|---|---|---|---|---|---|
| | Saline | | | (Desalinated | WHO |
| | Source Water | Desalinated | NF | Water + 1.1% | Drinking Water |
| | (Seawater) | Water | Retentate | NF Retentate) | Guidelines |
| pH | 8.1 | 5.2 | — | 6.1 | NL** |
| TDS* | 35607 | 50 | 47895 | 570 | ≤1,000 |
| Ca | 410 | 0.7 | 820 | 9.6 | Hardness (Ca + |
| Mg | 1310 | 0.4 | 2948 | 32.5 | Mg) ≥40 |
| Na | 10900 | 16.6 | 12263 | 149.8 | NL |
| K | 390 | 0.6 | 439 | 5.4 | NL |
| HCO₃ | 152 | 0.5 | 285 | 3.6 | NL |
| SO₄ | 2740 | 0.4 | 6508 | 71.2 | NL |
| Cl | 19700 | 29.3 | 24625 | 296.9 | No health-based |
| | | | | | guideline |
| B | 4.6 | 0.5 | 9 | 0.6 | ≤2.4 |
| LSI | — | −6.7 | — | −4.0 | NL |

*TDS and ions in ppm;
**NL: No Limit

In a further embodiment, NF may be used to treat only a small portion of the source seawater, either after pretreatment or installed separately and independently of the desalination system, in order to produce NF retentate desirably rich in calcium and magnesium to be utilized in the re-mineralization process.

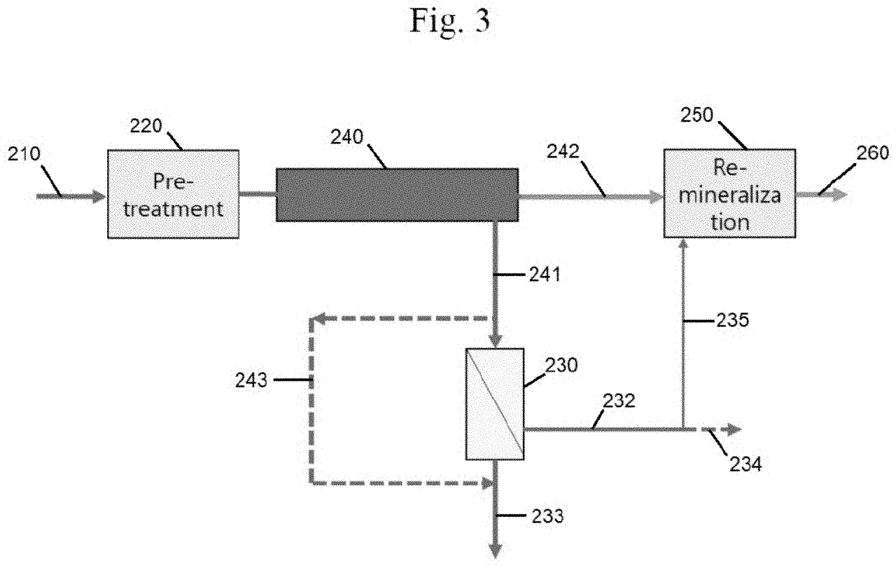

The present invention's use of an NF retentate discharge stream which is rich is divalent ions for re-mineralization of desalinated water is applicable to desalination plants that process source brackish water, seawater and/or wastewater, and is not limited to NF processing solely upstream of a desalination process. For example, in another embodiment of the present invention as illustrated in FIG. 3, the NF processing is performed downstream of the desalination unit 240 on the desalination unit retentate, followed by at least a portion of the NF unit retentate discharge being supplied to a re-mineralization process.

In this embodiment saline source water 210 passes through an initial pre-treatment process 220 prior the source water being directed to a desalination unit 240. The desalination unit 240 separates the saline water it receives into a desalination retentate stream 241 and a desalination permeate (desalinated water) stream 242. At least a portion of the desalination retentate stream 241 enters a NF unit 230, which separates the desalination retentate into an NF high divalent ion retentate stream that is rejected from the unit via discharge line 232, and into a low divalent ion-concentration NF permeate stream 233. The NF permeate stream 233 may be separately utilized in other processes, or may be recycled to the inlet of the desalination unit 240 to maximize desalinated water production and, due to its low divalent ion concentration, to assist in decreasing deposit and scale formation in the desalination unit. If only a portion of the source water is to be treated by the NF unit 230, the remainder may bypass the NF unit via line 243.

A portion of the NF retentate stream 234 that is discharged via line 232 may be diverted via line 235 for use in the post-treatment re-mineralization unit 250. At the re-mineralization unit 250, the desalination unit permeate stream 242 (i.e., the desalinated water) is mixed with the portion of the NF retentate discharge stream diverted via line 235 to treat the desalinated water to generate the output potable water stream 260.

Another embodiment similar to the FIG. 3 embodiment is within the scope of the present invention. Because the desalination retentate discharge stream in the FIG. 3 embodiment is expected to be more concentrated than the source saline water, the nanofiltration unit may be smaller than in the FIG. 2 embodiment. Alternatively or in addition, due to the quality of the desalination retentate discharge stream as compared to the source saline water, the nanofiltration unit may be replaced by another ion-selective membrane system, or other process (such as ion exchange used to generate divalent ions such as calcium and magnesium that add hardness to the water with which they are blended), as long as the system rejects more divalent ions than monovalent ions in its retentate discharge stream, even if the ion-selective membrane is not classified as a “nanofiltration” membrane.

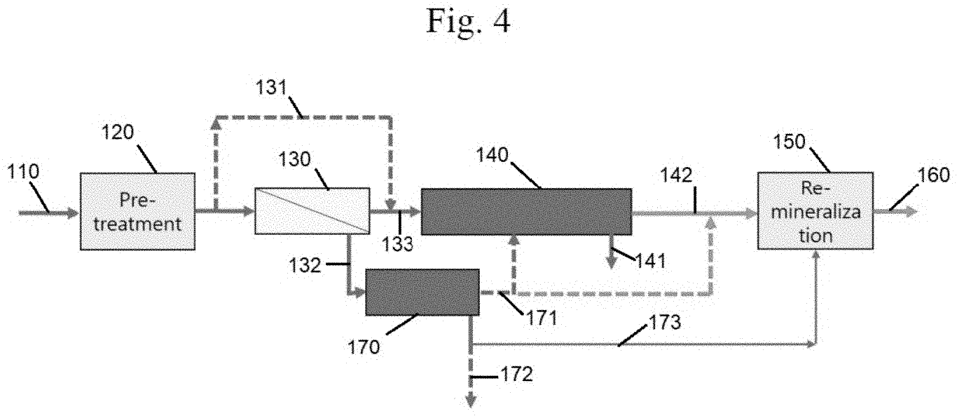

FIG. 4 illustrates a further embodiment of the invention illustrated in FIG. 2, which features the addition of a desalination or brine concentrator 170 that receives the NF retentate discharge stream before a portion of the NF retentate is supplied to the re-mineralization unit 150. This additional water treatment system permeate 171 may be expected to have a lower concentration than the NF retentate stream, and to be suitable for introduction to the desalination unit (or if of low enough concentration, introduced directly into the desalinated water stream 142), thereby increasing desalinated water production. The concentrator retentate stream 172 will have an even higher calcium and magnesium concentration than the NF retentate discharge stream, and thus the volume of the concentrator retentate stream diverted via line 173 to the re-mineralization unit 150 may be reduced relative to that in the FIG. 2 embodiment, while still supplying sufficient amount of calcium and magnesium to meet the desired potable water quality objectives.

Another embodiment of the present invention is arranged as in the FIG. 4 embodiment, except that the additional desalination or brine concentrator 170 may be one or more additional nanofiltration units 170. As with the FIG. 4 embodiment, the permeate stream(s) from the one or more additional system nanofiltration units 170 may be supplied to the desalination unit 140 or combined with the desalinated water 142.

In the present invention, the desalinated water quality is highly dependent on the desalination system performance, and the quality of the water being input into the system. Similarly, the NF retentate quality is also highly dependent on the NF membrane performance and the NF system configuration and operating conditions. Consequently, the 1.1% mixing of NF retentate in the foregoing embodiments is only an example. The mixing rate may be adjusted as necessary to meet the desired end-product drinking water qualities.

The foregoing disclosure has been set forth merely to illustrate the invention and is not intended to be limiting. Because such modifications of the disclosed embodiments incorporating the spirit and substance of the invention may occur to persons skilled in the art, the invention should be construed to include everything within the scope of the appended claims and equivalents thereof.

### LISTING OF REFERENCE LABELS

1 desalinated water
2 branch
3 CO₂ gas
4 CO₂ absorber
5 limestone filter
6 degasifier
7 chlorine gas
8 NaOH
9 potable water
110 source water
120 pretreatment unit
130 nanofiltration unit
131 bypass line
132 NF retentate discharge line
133 NF permeate stream
134 NF retentate stream
135 NF retentate branch line
140 desalination unit
141 desalination retentate discharge
142 desalinated water
150 re-mineralization unit
160 potable water
170 desalination or brine concentrator
171 concentrator permeate
172 concentrator retentate
173 diverted concentrator retentate stream line
210 source water
220 pretreatment unit
230 nanofiltration unit
232 NF retentate discharge line
233 NF permeate stream
234 NF retentate stream
235 NF retentate branch line
240 desalination unit
241 desalination retentate discharge
242 desalinated water
243 bypass line
250 re-mineralization unit
260 potable water

What is claimed is:

1. A re-mineralization system, comprising:
a nanofiltration unit;
a desalination unit; and
a re-mineralization unit,
wherein
the nanofiltration unit is configured to receive at least a first portion of a saline source stream,
the desalination unit is configured to receive at least a first portion of a nanofiltration permeate stream and to produce a desalinated water stream, and
the re-mineralization unit is configured introduce at least a first portion of a nanofiltration retentate discharge stream into at least a first portion of the desalinated water stream.

2. The re-mineralization system of claim 1, wherein
an amount of the first portion of the nanofiltration retentate discharge stream relative to an amount of the first portion of the desalinated water stream introduced in the re-mineralization unit is sufficient to convert the desalinated water into potable water conforming to a drinking water standard.

3. The re-mineralization system of claim 2, further comprising:
a pretreatment unit upstream of the nanofiltration unit and the desalination unit,
wherein the pretreatment unit is configured to receive a source saline water stream and discharge pretreated saline water to the nanofiltration unit, the desalination unit, or both the nanofiltration unit and the desalination unit.

4. The re-mineralization system of claim 3, wherein
a first portion of the pretreated saline water is received by the nanofiltration unit, and
the desalination unit receives a second portion of the pretreated saline water.

5. The re-mineralization system of claim 2, further comprising:
at least one concentration unit between the nanofiltration unit and the re-mineralization unit.

6. The re-mineralization system of claim 3, further comprising:
at least one concentration unit between the nanofiltration unit and the re-mineralization unit.

7. The re-mineralization system of claim 4, further comprising:
at least one concentration unit between the nanofiltration unit and the re-mineralization unit.

8. The re-mineralization system of claim 5, wherein
the at least one concentration unit includes a brine concentrator, an additional nanofiltration unit or an additional desalination unit, or a combination of two or more of the brine concentrator, the additional nanofiltration unit and the additional desalination unit.

9. The re-mineralization system of claim 6, wherein
the at least one concentration unit includes a brine concentrator, an additional nanofiltration unit or an additional desalination unit, or a combination of two or more of the brine concentrator, the additional nanofiltration unit and the additional desalination unit.

10. The re-mineralization system of claim 7, wherein
the at least one concentration unit includes a brine concentrator, an additional nanofiltration unit or an additional desalination unit, or a combination of two or more of the brine concentrator, the additional nanofiltration unit and the additional desalination unit.

11. A re-mineralization system, comprising:
a nanofiltration unit;
a desalination unit; and
a re-mineralization unit,
wherein
the desalination unit is configured to receive at least a first portion of a saline source stream and to produce a desalinated water stream and a desalination unit retentate discharge stream,
the nanofiltration unit is configured to receive at least a first portion of the desalination unit retentate discharge stream from the desalination unit, and
the re-mineralization unit is configured introduce at least a first portion of a nanofiltration retentate discharge stream into at least a first portion of the desalinated water stream.

12. The re-mineralization system of claim 11, further comprising:
a pretreatment unit upstream of the nanofiltration unit and the desalination unit,
wherein the pretreatment unit is configured to receive a source saline water stream and discharge pretreated saline water to the nanofiltration unit, the desalination unit, or both the nanofiltration unit and the desalination unit.

13. The re-mineralization system of claim 12, wherein
all of the pretreated saline water is received by the desalination unit.

14. The re-mineralization system of claim 11, further comprising:
at least one concentration unit between the nanofiltration unit and the re-mineralization unit.

15. The re-mineralization system of claim 12, further comprising:
at least one concentration unit between the nanofiltration unit and the re-mineralization unit.

16. The re-mineralization system of claim 11, wherein
the at least one concentration unit includes a brine concentrator, an additional nanofiltration unit or an additional desalination unit, or a combination of two or more of the brine concentrator, the additional nanofiltration unit and the additional desalination unit.

17. The re-mineralization system of claim 12, wherein
the at least one concentration unit includes a brine concentrator, an additional nanofiltration unit or an additional desalination unit, or a combination of two or more of the brine concentrator, the additional nanofiltration unit and the additional desalination unit.

18. A re-mineralization system, comprising:
an ion-selective membrane unit;
a desalination unit; and
a re-mineralization unit,
wherein
the ion-selective unit is configured to receive a saline source stream,
the desalination unit is configured to produce a desalinated water stream,
the re-mineralization unit is configured introduce at least a first portion of an ion-selective retentate discharge stream into at least a first portion of the desalinated water stream.
